(19) United States
(12) Patent Application Publication
(10) Pub. No.: US 2011/0058904 A1
(43) Pub. Date: Mar. 10, 2011

(54) Stabilizing Reinforcement For Use In Reinforced Soil Works

(75) Inventor: Nicholas Freitag, Orsay (FR)

(73) Assignee: TERRE ARMEE INTERNATIONALE, Velizy Villacoublay (FR)

(21) Appl. No.: 12/936,882

(22) PCT Filed: Apr. 3, 2009
(86) PCT No.: PCT/FR09/50573

§ 371 Date: Oct. 7, 2010

(30) Foreign Application Priority Data
Apr. 8, 2008 (FR) 08 52340

(51) Int. Cl. E02D 3/00; B23P 11/00

(52) U.S. Cl. 405/284; 405/302.4; 29/428

(57) ABSTRACT

Stabilizing reinforcement (1) for use in reinforced soil works, comprising two longitudinal parts (11, 21, 31, 41, 44, 61, 71, 73) forming a non-zero angle a+β with respect to each other and connected to each other by transverse parts (15, 46, 56, 65, 66, 75, 77) which are movable relative to at least one longitudinal part (11, 21, 31, 41, 44, 61, 71, 73) and comprise angular limit pieces (16, 48, 57, 58, 59, 67, 68, 76, 78) for limiting the angular separation of said two longitudinal parts, where the range of movement of the transverse parts (15, 46, 56, 65, 66, 75, 77) occurs within a perimeter defined by the two longitudinal parts (11, 21, 31, 41, 44, 61, 71, 73), their point of intersection or the line joining the two nearest ends of the two longitudinal parts, and the line joining the other two, or most separated, ends of the two longitudinal parts. Reinforced soil work comprising such a reinforcement. Method of construction for a reinforced soil work.

The present invention relates to a stabilising reinforcement intended for use in reinforced soil structures, as well as the use of such a reinforcement for the construction of reinforced soil structures.

A reinforced soil structure combines a compacted fill, a facing and reinforcements that may or may not be connected to the facing.

The facing is for example made from precast concrete elements, in the form of slabs or blocks, juxtaposed to cover the front surface of the structure. A structure built in this way is known in particular under Terre Armée Internationale's brand name Terra Class.

The facing can also be made from a net, particularly constituted of metal rods welded together. Such facing can include a geosynthetic fabric and can receive planting. A structure built in this way is known in particular under Terre Armée Internationale's brand name Terra Trel.

Various types of reinforcement can be used: metal, for example comprising galvanised steel rods, or made from a synthetic material such as stabilising strips for example based on polyester fibres. The reinforcements are placed in the soil at a density that depends on the stresses that might be exerted on the structure, as the active earth pressure of the ground is taken up by the soil-reinforcement friction.

The stabilising reinforcements are attached to the facing and/or a wall located at a distance from the facing.

The stabilising reinforcements intended for use in reinforced soil structures comprise elongated longitudinal parts. Their length is of the order of magnitude of the metre. They can be several metres long. The longitudinal parts of the reinforcements can be arranged one by one in the soil, or be assembled together by various means. The width and thickness of such longitudinal parts are of the order of the centimetre, and do not generally exceed approximately ten centimetres.

The longitudinal parts can be arranged substantially perpendicular to the facing or be arranged slanting relative to the facing. In the latter case, the longitudinal parts are generally arranged on either side of an axis perpendicular to the facing. Generally, the longitudinal parts of the reinforcements are arranged in a substantially horizontal plane.

Metal stabilising reinforcements are often seen as advantageous in terms of price and are generally constituted of metal rods welded together to form for example ladders or a mesh.

A ladder reinforcement is generally constituted of two substantially parallel metal rods, each forming a longitudinal part, and transverse rods that connect the longitudinal rods to each other in order to stiffen the assembly.

By “transverse” is meant a part of a reinforcement that connects two longitudinal parts to each other. Such parts are for example constituted of rods. Consequently, the transverse parts are arranged so that they are substantially parallel or slanting relative to a facing.

The transverse rods of ladder reinforcements are generally arranged perpendicular to the longitudinal rods. They can however be inclined relative to the longitudinal rods.

The transverse rods are generally distributed over the entire length of the longitudinal rods and particularly evenly spaced. For example, the spacing between two transverse rods is of the order of several tens of centimetres for a normal ladder reinforcement.

A reinforcement that resembles a ladder is thus formed.

Generally, one end of the ladder reinforcement comprises a means of fixing to the facing, particularly hooks formed or arranged at one end of the longitudinal rods, or a flat, perforated piece connecting the ends of two longitudinal rods, in which the perforated part of said piece is intended to receive means of connection with the facing.

The metal rods used for such reinforcements are generally steel rods. They are often cylindrical and their diameter is generally of the order of the centimetre. These rods are advantageous to use as they are very moderately priced. However, the environment in which they are arranged is corrosive, particularly due to the pH of the soils and the ions they contain, which can moreover vary over time and as a function of rainfall or other parameters.

It is therefore convenient to protect the steel reinforcements in order to ensure a satisfactory service life of the structures built.

In order to produce a durable metal ladder stabilising reinforcement, the following steps are usually carried out:
arranging two longitudinal rods substantially parallel to each other,
arranging the transverse rods, generally orthogonally to the longitudinal rods,
welding the transverse rods to the longitudinal rods,
galvanising the assembly.

Such a ladder stabilising reinforcement has several drawbacks. Firstly, it is often necessary to move it, or even transport it from a distant production site before installing it on a soil reinforcement site. The associated transport costs can be high as such reinforcements are bulky.

Furthermore, the inventors have established that the welds are sometimes weak points on a ladder reinforcement. It appears that the protection by galvanising is often imperfect in the weld zones, thus resulting in the risk of localised corrosion and a significant reduction in the strength of the assembly. One solution can be to increase the safety factors for a given structure, for example by increasing the density of reinforcements. Such a solution is however costly and unsatisfactory.

It is also possible, in order to form a ladder stabilising reinforcement, to use steel wires or bars, previously continuously coated with a zinc-aluminium alloy, which are cut to the desired dimensions and then welded. It has been found that the welds can significantly damage the protective coating and this damage can also reduce the strength of the reinforcement.

An object of the present invention is to overcome the aforementioned drawbacks and particularly to propose a reinforcement without the risks associated with the corrosion of the welds between longitudinal parts and transverse parts.

The invention thus proposes a stabilising reinforcement intended for use in reinforced soil structures, comprising two longitudinal parts forming a non-zero angle α+β with respect to each other and connected to each other by transverse parts which are movable relative to at least one longitudinal part and comprise angular limit pieces making it possible to limit the angular separation of said two longitudinal parts.

The invention also proposes a stabilising reinforcement intended for use in reinforced soil structures, comprising two longitudinal parts forming a non-zero angle α+β with respect to each other and connected to each other by transverse parts which are movable relative to at least one longitudinal part and comprise angular limit pieces making it possible to limit the angular separation of said two longitudinal parts, where the range of movement of the transverse parts occurs within a perimeter defined by the two longitudinal parts, their point of intersection or the line joining the two nearest ends of the two longitudinal parts and the line joining the other two, or most separated, ends of the two longitudinal parts.

By “movable transverse parts” is meant transverse parts capable of undergoing movement relative to at least one longitudinal part. This movement can correspond to a translation, in which case the transverse part moves as a whole relative to the two longitudinal parts. This movement can also be a rotation. In certain cases of rotation, one point, particularly one end of a transverse part, can remain fixed relative to one longitudinal part, while the rest of the transverse part moves relative to the two longitudinal parts. It is also possible to combine a translation and a rotation.

Generally, the movement of a transverse part relative to a longitudinal part can occur from the area of the reinforcement where the two longitudinal parts are furthest away from each other towards the area where the longitudinal parts are nearest to each other, particularly towards the point where the axes of the two longitudinal parts intersect, that is, in the direction from the inside of the fill towards the facing when the reinforcement is arranged in a structure.

By “angular limit pieces for limiting the angular separation of two longitudinal parts” is meant any means making it possible to limit the angular separation of the two longitudinal parts, particularly by limiting a distance between two points of two separate longitudinal parts.

Using a stabilising reinforcement according to the invention, it is possible to avoid welding the longitudinal parts to the transverse parts. As a result, such a reinforcement no longer presents a risk of preferential corrosion.

Furthermore, it is thus possible to produce the reinforcement on the site of the reinforced soil structure, for example using previously galvanised metal rods or wires that are commercially available and shaping them, for example by folding or bending, in order to obtain the desired configuration of the reinforcement. It is therefore no longer necessary to perform a prior galvanising operation on the reinforcement at a production location distant from the site.

Remarkably, the combination of two longitudinal parts forming a non-zero angle α+β with respect to each other and the use of transverse parts comprising angular limit pieces makes it possible to ensure the stiffening of the reinforcement when said longitudinal parts come into contact with said limit pieces on the transverse parts.

According to various embodiments, which can be combined:
the longitudinal parts are metal, particularly galvanised steel, for example formed from cylindrical rods;
the transverse parts are metal, particularly galvanised steel, for example formed from cylindrical rods;
two longitudinal parts are connected to each other by material continuity to form a substantially V-shaped piece;
two longitudinal parts are independent and articulated so that they can form a non-zero angle α+β with respect to each other;
two independent longitudinal parts are articulated about the same axis, for example by means of hooks located at one of their ends;
two independent longitudinal parts are articulated about two different axes, for example by means of hooks located at one of their ends;
ends of two longitudinal parts are rigidly connected to each other;
the angular limit pieces on the transverse parts are hooks or heads located at each end of said transverse parts;
a plurality of transverse parts are of regularly increasing length and are capable of determining a plurality of maximum separation distances between two longitudinal parts;
one end of at least one transverse part is held movable in rotation in a housing in a longitudinal part;
one end of a longitudinal part is connected to a transverse part by material continuity by intermediate portions, for example substantially in the form of an elbow, V-shaped or U-shaped;
the transverse parts of the same stabilising reinforcement are connected to each other by material continuity by intermediate portions, for example substantially in the form of an elbow, V-shaped or U-shaped;
the angle α+β is comprised between 10° and 120°, preferably greater than or equal to 20° and/or less than or equal to 90°, or even substantially equal to 30°.

A further object of the invention is a reinforced soil structure comprising a facing running along a front surface of the structure and/or a wall delimiting a fill, where said fill is stabilised by at least one stabilising reinforcement according to the present invention.

A further object of the invention is a reinforced soil structure in which the angles α and β are substantially equal to each other, the angles α and β each measuring the angular separation between an axis orthogonal to the facing and one of the two longitudinal parts.

The structure built in this way is preferably obtained with a plurality of said stabilising reinforcements, each comprising two longitudinal parts, where the different reinforcements are separated from each other, without touching each other or being connected to each other by anything other than fill material. According to an embodiment, the different reinforcements are connected to the facing at regular intervals, both in a horizontal plane and in a plane parallel to the facing. A reinforced structure is thus obtained in a manner that is efficient and simple to implement.

The invention also relates to a construction method for a reinforced soil structure, in which a facing running along a front surface of the structure delimiting a volume to be filled is arranged at a distance from a wall, reinforcements are arranged in a zone of said volume, fill material is placed in said volume and the fill material is compacted, where said reinforcements are at least partly constituted of stabilising reinforcements according to the present invention.

According to an embodiment of the construction method, the stabilising reinforcements are arranged separated from each other, without touching or being connected to each other by anything other than fill material.

According to an embodiment of this method, two longitudinal parts are arranged, with one end of each longitudinal part connected to the facing or to the wall in a substantially horizontal plane, a plurality of elements comprising a transverse part are arranged and said transverse parts are moved relative to the longitudinal parts, for example in translation and/or rotation, in such a way as to delimit the angular separation α+β.

According to another embodiment of this method, two longitudinal parts are arranged, with one end of each longitudinal part connected to the facing or to the wall in a substantially horizontal plane, an element comprising a plurality of transverse parts with material continuity is arranged, in order to delimit the angular separation α+β.

According to another embodiment of this method, two longitudinal parts are arranged, with one end of each longitudinal part connected to the facing or to the wall in a substantially horizontal plane, one or both of the two longitudinal part(s) being connected by material continuity to a transverse part, the transverse part is moved in rotation relative to said longitudinal part in such a way as to delimit the angular separation α+β.

The invention will be more clearly understood on reading the following description, given by way of example only, with reference to the attached drawings, in which:

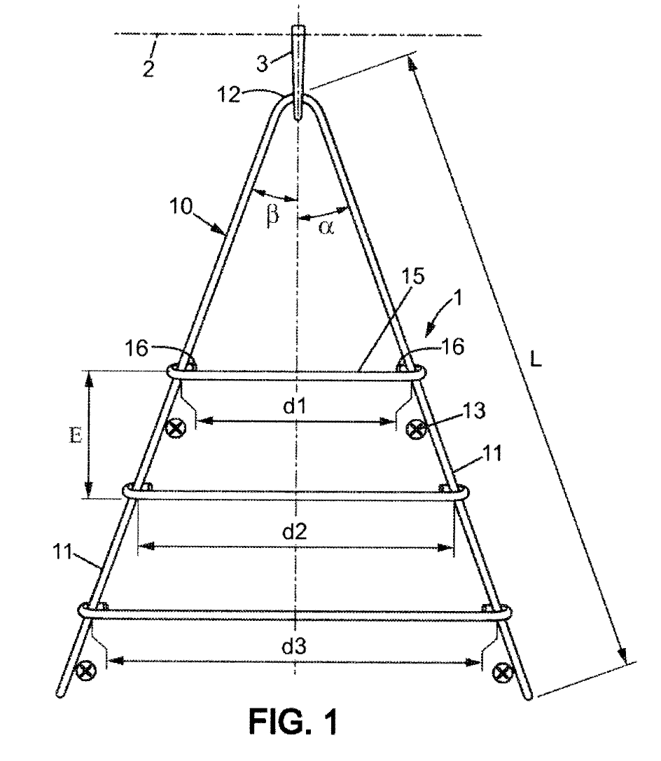

FIGS. 1 to 7 are diagrammatic views of different embodiments of a reinforcement according to the invention;

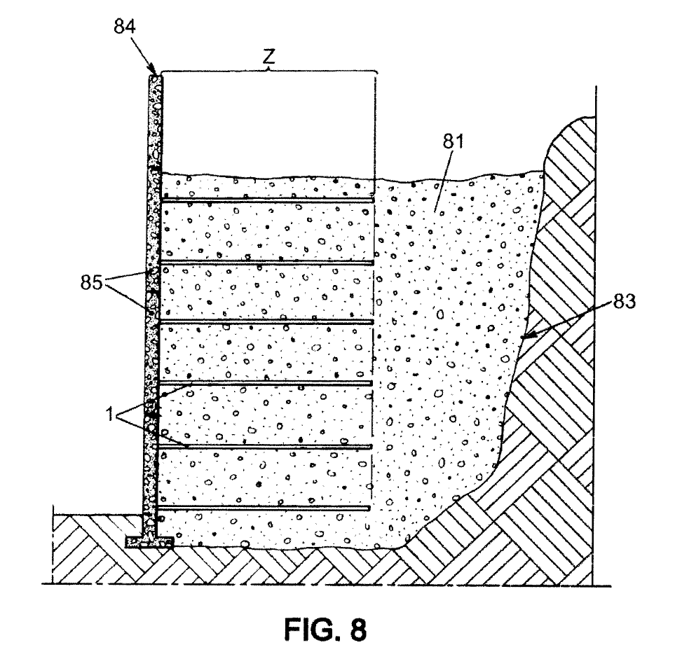

FIG. 8 is a diagrammatic cross-sectional view of a reinforced soil structure according to the invention, during construction.

For reasons of clarity, the different elements shown in the figures are not necessarily to scale. In the figures, identical reference numbers denote identical elements.

FIG. 1 shows a diagrammatic top view in which a stabilising reinforcement 1, according to the invention, is connected to a facing (not shown) at a point along a line 2. A facing is usually constituted of a plurality of facing elements, for example formed by a concrete block cast in a mould. The facing element can comprise one or more anchoring pieces, for example hook or ring, embedded in the concrete and extending beyond the concrete block along the line 2. The line 2 is generally substantially parallel to the front surface of the facing.

The reinforcement 1 is connected to an anchoring piece on a facing element by means of a hook 3.

The reinforcement shown extends generally substantially horizontally and rests on fill material.

The reinforcement 1 comprises two longitudinal parts 11, connected by continuity of material by an elbow 12 to form a substantially V-shaped piece 10, and a plurality of transverse parts 15. Non-limitatively, three transverse parts are shown. The transverse parts are of regularly increasing length, d₁, d₂, d₃. Each of their ends is equipped with a hook 16 the end of which faces towards the inside of the transverse parts.

The two transverse parts are angularly separated by a non-zero angle α+β, in this case of the order of 20° to 30°. In the configuration shown, the angles α and β are substantially equal, where the angles α and β each measure the angular separation between an axis orthogonal to the line 2 of the attachment points to the facing and the longitudinal part 11 located on the right of the figure and the longitudinal part 11 located on the left of the figure respectively.

The piece 10 can for example be formed on a site by bending a rod 2 L long in the middle to obtain two longitudinal parts 11 L long, separated by an angle α+β.

The transverse parts 15 can for example be formed on a site by bending the ends of a rod inwards in order to form the hooks 16.

The transverse parts 15 are arranged in such a way that the hooks 16 on each end of each transverse part clasp a longitudinal part 11 of the piece 10 and thus form angular limit pieces for limiting the angular separation of the two longitudinal parts 11.

Such a reinforcement 1 can be obtained by first placing the piece 10 on a fill, then sliding the transverse parts 15 in the direction from the elbow 12 towards the opposite ends of the longitudinal parts 11 until the hooks 16 abut against said longitudinal parts 11.

The three transverse parts 15 are then separated from each other by a value E and prevent the longitudinal parts 11 from separating from each other by more than d₁, d₂, d₃ respectively at the contact points.

For example, a hook 3 can then be arranged in the elbow 12 of the piece 10 and be hooked to an anchoring piece on the line 2.

Optionally, it is possible to prevent the longitudinal parts 11 from moving together by arranging nails 13 in the fill in contact with the longitudinal parts 11, on the inside of the V of the piece 10.

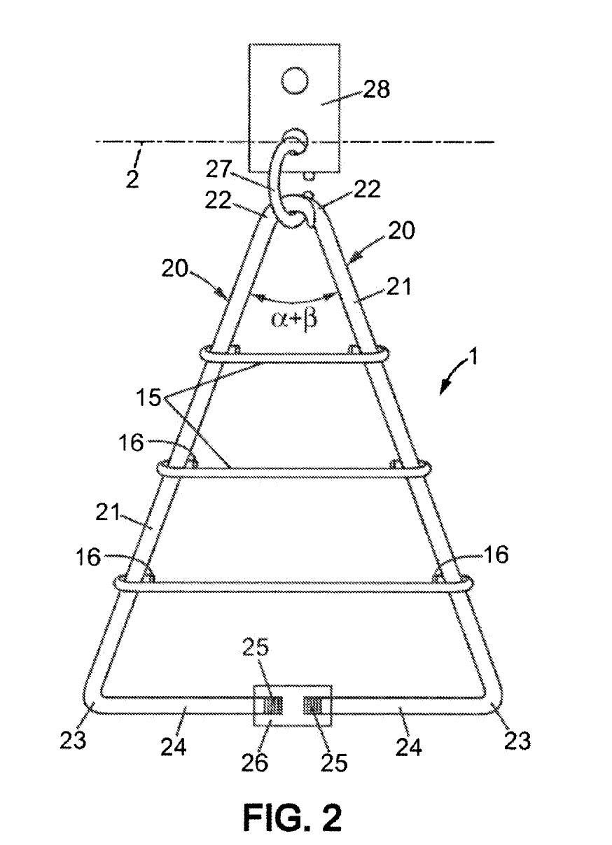

FIG. 2 shows a top view of another stabilising reinforcement 1 according to the invention. The reinforcement comprises two pieces 20 each comprising a longitudinal part 21 each with a hook 22 at one end.

The hooks 22 are arranged in a ring 27 that is connected to an anchoring plate 28. This plate can be integral with a facing element or can be attached to it. The two longitudinal parts 21 are separated by an angle α+β and their angular separation is limited by transverse parts 15 of the type described above.

Optionally, the ends of the longitudinal parts 21, opposite the ends on which the hooks 22 are arranged, are connected to each other. They can for example be connected to each other by parts 24 extending them. These parts 24 are substantially parallel to the transverse parts 15 and connected by material continuity by an elbow 23 to the longitudinal parts 21. The parts 24 can for example be connected to each other by means of threaded ends 25 held by a reverse-threaded piece 26.

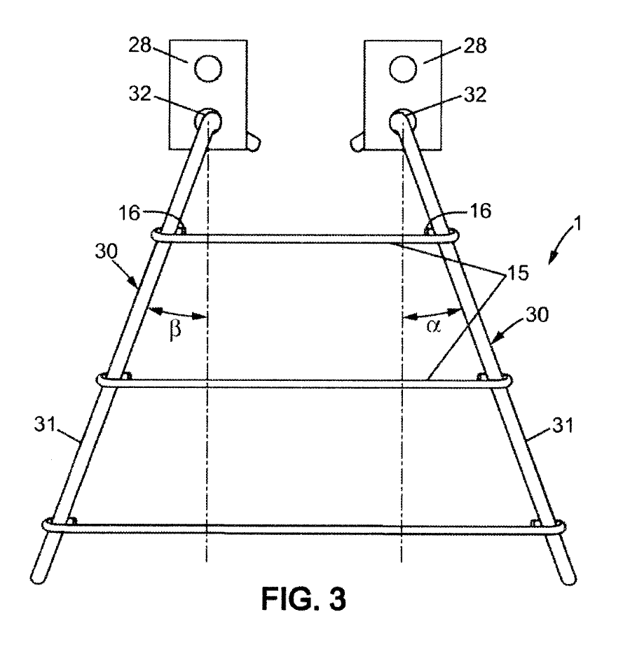

A variant of the embodiment in FIG. 2 is shown in FIG. 3, in which a stabilising reinforcement according to the invention comprises two pieces 30 each comprising a longitudinal part 31 and a head 32 at one end.

The heads 32 are arranged in one of the holes in an anchoring plate 28 of the type described above. The two anchoring plates are separated and the heads 32 of the pieces 30 are thus connected to the facing at separate points. It is thus possible to produce a wider stabilising reinforcement than those described above.

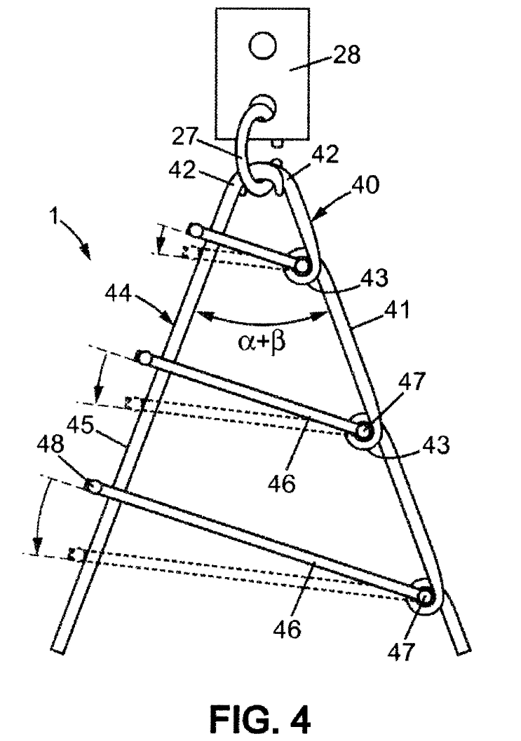

FIG. 4 shows a top view of a stabilising reinforcement 1 according to the invention that is a variant of the embodiment shown in FIG. 2. The reinforcement comprises two pieces 40 and 44 each comprising a longitudinal part 41 and 45 respectively each with a hook 42 at one end, arranged in a ring 27 connected to an anchoring plate 28.

The longitudinal part 45 of the piece 44 is straight.

The longitudinal part 41 of the piece 40 comprises housings 43.

This longitudinal part can be produced from a single rod by bending to form the housings 43 and the hook 42. It is also possible to obtain a piece of this type from a straight rod to which the housings are added, for example by screwing, welding or any other appropriate means.

The transverse parts 46 comprise at each of their ends heads 47, 48, for example obtained by bending a rod at 90°, or by adding an end 47, 48 forming a head by any other means known to a person skilled in the art. One of the heads 47 of each of the transverse parts 46 is arranged in a housing 43 on the longitudinal part 41.

The heads 47 and the housings 43 are, in the example shown, produced in such a way that the heads 47 can only move in rotation relative to their axis in the housings 43.

The reinforcement 1 shown in FIG. 4 can be obtained by placing the pieces 40 and 44 on a fill, attaching these pieces using their hooks 42 to a ring 27 connected to the facing, separating the two pieces 40 and 44 by the desired angle α+β, inserting the heads 47 into the housings 43 in the piece 40, and rotating the transverse parts 46 about the axis of the heads 47 until the heads 48 of said transverse parts come into contact with the piece 44 in order to limit the angular separation of the longitudinal parts 41 and 45.

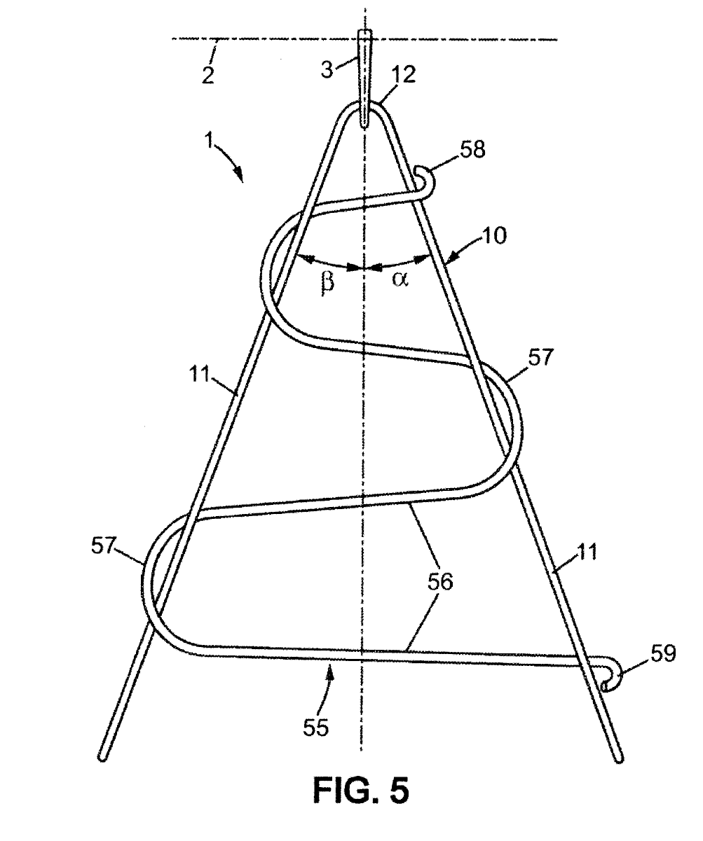

FIG. 5 shows a top view of a stabilising reinforcement 1 according yet another embodiment. This reinforcement comprises two longitudinal parts 11, connected by material continuity by an elbow 12 to form a piece 10 and a piece 55 comprising a plurality of transverse parts 56 connected by material continuity by elbows 57. It is entirely possible to replace the piece 10 comprising the transverse parts shown here by pieces 20 or 30 as shown in FIGS. 2 and 3 respectively.

The piece 55 comprises at its ends hooks 58, 59. Such a piece 55 can be produced by bending a rod.

The reinforcement 1 shown in FIG. 5 can be obtained by sliding the piece 55 on the piece 10 from the elbow 12, for example by inserting the longitudinal parts 11 into the loops formed by an elbow 57 and the two transverse parts 56 attached to it. The piece 55 thus passes above and below the piece 10. The hooks 58, 59 form angular limit pieces for limiting the angular separation α+β of the longitudinal parts 11.

It is possible to design the piece 55 in such a way that the inside part of the elbows 57 is in contact with the longitudinal parts 11 when the hooks 58, 59 contact said longitudinal parts. In this configuration, the elbows 57 also form angular limit pieces for limiting the angular separation of the two longitudinal parts.

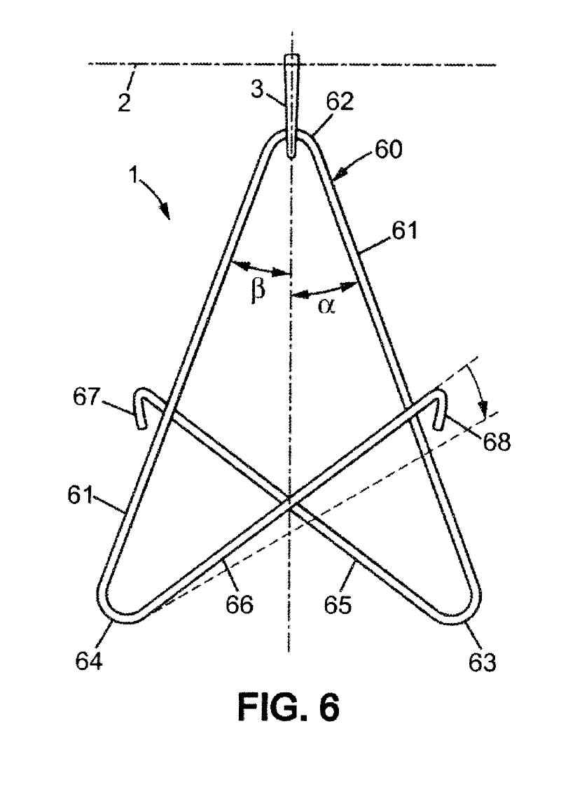

FIG. 6 shows another embodiment of a stabilising reinforcement 1 according to the invention, constituted of a continuous piece 60. This reinforcement comprises two longitudinal parts 61, connected by material continuity by an elbow 62 and two transverse parts 65, 66, each connected by material continuity by an elbow 63, 64 respectively to the longitudinal parts 61.

A hook 67, 68 is arranged at the other end of each transverse part 65, 66. Such a reinforcement can be obtained by bending a single rod.

The transverse parts 65, 66 can be moved, for example by rotation about the axis of the elbows 63, 64, by slightly deforming the elbows, in such a way as to bring the hooks 67, 68 into contact with the longitudinal parts 61 and thus form angular limit pieces making it possible to limit the angular separation of the two longitudinal parts.

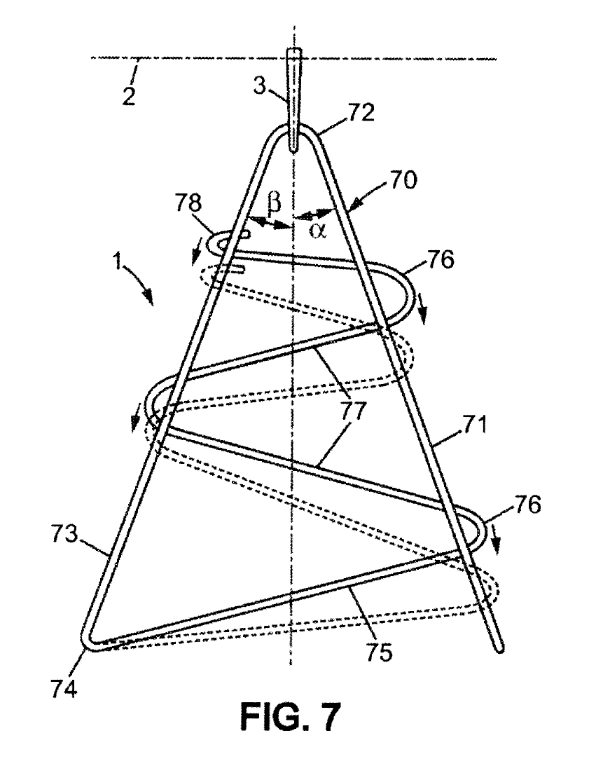

FIG. 7 shows another embodiment of a stabilising reinforcement 1 according to the invention that can also be obtained by bending a single rod and form a continuous piece 70.

This reinforcement comprises two longitudinal parts 71, 73, connected by material continuity by an elbow 72 and a plurality of transverse parts 75, 77. The transverse part 75 is connected by material continuity to the longitudinal part 73 by an elbow 74. The other transverse parts 77 are connected by material continuity to each other by elbows 76, and one of them is connected by material continuity by an elbow 76 to the transverse part 75. A hook 78 is arranged at the end of the transverse part 77 furthest from the transverse part 75.

The hook 78 forms an angular limit piece for limiting the angular separation of the two longitudinal parts 71, 73, as do the elbows 76, which are designed in such a way that their inside part comes into contact with the longitudinal parts 71, 73 when the hook 78 is in contact with the longitudinal part 73.

It will be noted that for all of the embodiments shown, the range of movement of the transverse parts 15, 46, 56, 65, 66, 75, 77 occurs inside a perimeter defined by the two longitudinal parts 11, 21, 31, 41, 44, 61, 71, 73, their point of intersection or the line joining the two nearest ends of the two longitudinal parts and the line joining the other two, or most separated, ends of the two longitudinal parts.

In the examples shown in FIGS. 1, 2, 4, 5, 6 and 7, the perimeter is defined by the two longitudinal parts, 11, 21, 41 and 44, 11, 61 respectively, which meet at a point of intersection, respectively located in the elbow 12, at the overlap of the hooks 22, the hooks 42, in the elbows 12, 62, 72 and by the line joining the other two, most separated, ends of these two longitudinal parts 11, 21, 41 and 44, 11, 61 respectively.

In the example shown in FIG. 3, the perimeter is defined by the two longitudinal parts 31, the line passing through their two nearest ends passing through the heads 32 and the line joining the other two, most separated, ends of these two longitudinal parts 31.

The invention also relates to a construction method for a reinforced soil structure.

FIG. 8 shows such a method. A compacted fill 81, in which stabilising reinforcements 1 according to the invention are distributed, is delimited on the front side of the structure by a facing 84 constituted by juxtaposing prefabricated elements 85, and on the rear side by the ground 83 against which the retaining wall is erected.

To ensure the cohesion of the retaining wall, the stabilising reinforcements 1 can be connected to the facing elements 85, and extend over a certain distance within the fill 81. These stabilising reinforcements 1 contribute to reinforcing the soil located in a reinforced zone Z behind the facing 84.

In the reinforced zone Z, the fill material 81 is very strong due to the fact that it is reinforced by stabilising reinforcements 1. It is thus able to withstand the shear stresses exerted due to the tensile loads to which the stabilising reinforcements 1 are subject. This reinforced zone Z must naturally be thick enough to support the facing 84.

The simple connection of stabilising reinforcements to the back of the facing elements 85 thus allows for the facing to be held against the fill, which can be of a large volume.

The stabilising reinforcements are generally connected by connecting means, particularly hooks or rings, to the back of the facing elements 85.

In the example of a structural configuration shown in FIG. 8, the stabilising reinforcements 1 are arranged in superimposed horizontal planes alternating over the height of the structure.

To build the structure shown in FIG. 8, the following method can be used:

a) position a part of the facing elements 85 so that fill material can then be placed over a certain height. In a known manner, the assembly and positioning of the facing elements can be facilitated by assembly components placed between them;

b) install stabilising reinforcements 1 on the fill already present;

c) place fill material on top of the layer of stabilising reinforcements 1 that has just been installed, up to the next level of stabilising reinforcements 1 on the rear side of the facing elements 84. This fill material is compacted as it is placed;

d) repeat steps a) to c) until the top level of fill is reached.

According to a variant of said construction method for a reinforced soil structure, the stabilising reinforcements 1 are attached to the facing 83.

It is possible to attach the stabilising reinforcements both to the facing 84 and the wall 83. The attachment to the wall can be by means of nailing an anchoring element into the wall 83, to which for example a ring is connected. A hook, for example, is then arranged allowing for said ring and a stabilising reinforcement to be connected.

By way of example, a reinforcement of the type of reinforcement shown in FIG. 2 can be attached to the wall by a hook located along the parts 24 or in an elbow 23, a reinforcement shown in FIG. 6, by a hook located in an elbow 63 or 64, or a reinforcement shown in FIG. 7, by a hook located in the elbow 74. The connection of a reinforcement on which one end of the longitudinal part 11, 31, 41, 44, 71 is free can also be envisaged by adding to that end a hook or a ring allowing for the insertion of a connection element to the wall.

It is also possible to use the reinforcements according to the invention and only attach them to a wall. In this case, it must be understood that the narrowest part of the stabilising reinforcements is facing the wall 83 to which it is connected. The line 2 represents in this case the line of the anchoring points to the wall. For example, the plates 28 can be connected to the wall by nailing.

It is also possible to alternate the attachment of the reinforcements according to the invention, with one reinforcing layer being attached to the wall and the reinforcing layer located above and/or below being connected to a facing. Preferably the projections in a horizontal plane of the reinforcements attached to the wall and those attached to the facing have an overlapping zone.

It must be noted that a great number of variants can be applied to the structure described above and to its construction method.

The invention is not limited to these types of embodiment and must be interpreted in a non-limitative manner that encompasses any equivalent embodiment.

1. Stabilising reinforcement (1) intended for use in reinforced soil structures, comprising two longitudinal parts (11, 21, 31, 41, 44, 61, 71, 73) forming a non-zero angle α+β with respect to each other and connected to each other by transverse parts (15, 46, 56, 65, 66, 75, 77) which are movable relative to at least one longitudinal part (11, 21, 31, 41, 45, 61, 71, 73) and comprise angular limit pieces (16, 48, 57, 58, 59, 67, 68, 76, 78) for limiting the angular separation of said two longitudinal parts, where the range of movement of the transverse parts (15, 46, 56, 65, 66, 75, 77) occurs within a perimeter defined by the two longitudinal parts (11, 21, 31, 41, 44, 61, 71, 73), their point of intersection or the line joining the two nearest ends of the two longitudinal parts and the line joining the other two, most separated, ends of the two longitudinal parts.

2. Stabilising reinforcement (1) according to the previous claim, characterised in that the longitudinal parts (11, 21, 31, 41, 44, 61, 71, 73) are metal, particularly galvanised steel, for example formed from cylindrical rods.

3. Stabilising reinforcement (1) according to any one of the previous claims, characterised in that the transverse parts (15, 46, 56, 65, 66, 75, 77) are metal, particularly galvanised steel, for example formed from cylindrical rods.

4. Stabilising reinforcement (1) according to any one of the previous claims, characterised in that two longitudinal parts (11, 61, 71, 73) are connected to each other by material continuity to form a substantially V-shaped piece (10, 60, 70).

5. Stabilising reinforcement (1) according to any one of claims 1 to 3, characterised in that two longitudinal parts (21, 31, 41, 45) are independent and articulated in order to form a non-zero angle α+β with respect to each other.

6. Stabilising reinforcement (1) according to the previous claim, characterised in that the two independent longitudinal parts (21, 41, 45) are articulated about the same axis, for example by means of hooks (22, 42) located at one of their ends.

7. Stabilising reinforcement (1) according to claim 5, characterised in that the two independent longitudinal parts (31) are articulated about two different axes, for example by means of hooks (32) located at one of their ends.

8. Stabilising reinforcement (1) according to any one of the previous claims, characterised in that ends (23) of the two longitudinal parts (21) are rigidly connected to each other.

9. Stabilising reinforcement (1) according to any one of the previous claims, characterised in that the angular limit pieces on the transverse parts (15, 41, 45, 55, 65, 66, 77) are hooks (16, 58, 59, 67, 68, 78) or heads (47, 48) located at each end of said transverse parts (15, 41, 45, 55, 65, 66, 77).

10. Stabilising reinforcement (1) according to any one of the previous claims, characterised in that it comprises a plurality of transverse parts (15, 46, 56, 75, 77) of regularly increasing length and capable of determining a plurality of maximum separation distances (d₁, d₂, d₃) between two longitudinal parts (11, 21, 31).

11. Stabilising reinforcement (1) according to any one of the previous claims, characterised in that one end (47) of at least one transverse part (46) is held movable in rotation in a housing (43) in a longitudinal part (41).

12. Stabilising reinforcement (1) according to any one of the previous claims, characterised in that one end of a longitudinal part (61, 71, 73) is connected to a transverse part (65, 66, 75) by material continuity by intermediate portions (63, 64, 74), for example substantially in the form of an elbow, V-shaped or U-shaped.

13. Stabilising reinforcement (1) according to any one of claims 1 to 9, characterised in that the transverse parts (56, 75, 77) of the same stabilising reinforcement (1) are connected to each other by material continuity by intermediate portions (57, 76), for example substantially in the form of an elbow, V-shaped or U-shaped.

14. Stabilising reinforcement (1) according to any one of the previous claims, characterised in that the angle α+β is comprised between 10° and 120°, preferably greater than or equal to 20° and/or less than or equal to 90°, or even substantially equal to 30°.

15. Reinforced soil structure comprising a facing (84) running along a front surface of the structure and/or a wall (83) delimiting a fill (81), where said fill is stabilised by at least one stabilising reinforcement (1) according to any one of claims 1 to 14.

16. Structure according to the previous claim, in which the angles α and β are substantially equal to each other, the angles α and β each measuring the angular separation between an axis orthogonal to the facing (84) and one of the two longitudinal parts (11, 21, 31, 41, 45, 61, 71, 73).

17. Construction method for a reinforced soil structure, in which a facing (84) running along a front surface of the structure delimiting a volume to be filled is arranged at a distance from a wall (83), reinforcements (1) are arranged in a zone of said volume, fill material (81) is placed in said volume and the fill material (81) is compacted, characterised in that said reinforcements (1) are at least partly constituted of stabilising reinforcements (1) according to any one of claims 1 to 14.

18. Construction method according to the previous claim, characterised in that two longitudinal parts (11, 21, 31, 41, 45) are arranged, connecting one end of each longitudinal part to the facing (24) or to the wall (83) in a substantially horizontal plane, a plurality of elements comprising a transverse part (15, 46) are arranged and said transverse parts are moved relative to the longitudinal parts, for example in translation and/or rotation, in such a way as to delimit the angular separation α+β.

19. Construction method according to claim 17, characterised in that two longitudinal parts (11) are arranged, connecting one end of each longitudinal part to the facing (24) or to the wall (83) in a substantially horizontal plane, an element (55) comprising a plurality of transverse parts (56) with material continuity is arranged, in order to delimit the angular separation α+β.

20. Construction method according to claim 17, characterised in that two longitudinal parts (61, 71, 73) are arranged, connecting one end of each longitudinal part to the facing (24) or to the wall (83) in a substantially horizontal plane, one or both of the two longitudinal part(s) (61, 73) being connected by material continuity to a transverse part (65, 66, 75), the transverse part (65, 66, 75) is moved in rotation relative to said longitudinal part (61, 73) in such a way as to delimit the angular separation α+β.
